(19) United States
(12) Patent Application Publication
(10) Pub. No.: US 2002/0149794 A1
(43) Pub. Date: Oct. 17, 2002

(54) Image forming apparatus for collective printing and collective printing method

(76) Inventors: Yoshiki Yoshioka, Osaka (JP); Koji Minakuchi, Osaka (JP); Yasuhiko Kida, Osaka (JP)

Correspondence Address: RABIN & BERDO, P.C., SUITE 500, 1101 14th STREET, N.W., WASHINGTON, DC, 20005, US

(21) Appl. No.: 10/104,056

(22) Filed: Mar. 25, 2002

(30) Foreign Application Priority Data
Mar. 27, 2001 (JP) 2001-090075

(51) Int. Cl. G06K 1/00; G06F 15/00

(52) U.S. Cl. 358/1.18

(57) ABSTRACT

According to the present invention, an image forming apparatus capable of arranging plural images read from plural originals in a predetermined layout in the order of reading and collectively printing the arranged images, the apparatus includes re-layout means for inserting an image independent from the plural read images in an arbitrary place of the layout and re-arranging the images by sequentially pushing back an image, previously allotted to the place with the inserted image, and the succeeding images. Printed matters in various formats of collective printing can be produced because the apparatus is adapted to lay out the images read from the originals in the order of reading and to insert an image independent from the read images in an arbitrary place of the layout. A user of the image forming apparatus, in particular, can obtain printed matters in favorable collective printed form because the user is allowed to add/insert an image to the images to be collectively printed as well as to select an arbitrary place to insert the image, depending on the purpose of the printed matters to be used or distributed.

This application is based on an application No. 2001-090075 filed in Japan, the content of which is incorporated herein by reference.

### BACKGROUND OF THE INVENTION

1. Field of the Invention

The present invention relates to an image forming apparatus capable of collectively printing, in a predetermined layout, a plurality of images read from a plurality of originals.

2. Description of Related Art

There exists an image forming apparatus capable of collectively printing, in a predetermined layout, a plurality of images read from a plurality of originals. The collective printing means the following. In a case where the image forming apparatus reads eight images from eight originals, for example, the apparatus collectively prints 4-page images on each of two sheets A, B in a layout wherein a print region of each of the sheets A, B is divided into four portions, as schematically shown in FIG. 1. In this example, images i1, i2, i3 and i4 are collectively printed on a front surface (print region) of the sheet A, whereas images i5, i6, i7 and i8 are collectively printed on a front surface (print region) of the sheet B.

This example is generally called “4-page collective printing” because images for four pages are collectively printed on one print region of a sheet.

In another example of the collective printing, a plurality of images are printed on sheets in a manner to comply with the bookbinding method for weekly magazine et al. This printing method is generally called “weekly-magazine printing”. The bookbinding method for weekly magazine et al. includes folding a sheet into two, stacking a plurality of sheets thus folded on top of each other with their folding lines aligned, and stapling the sheets along the folding lines by means of a stapler. An image layout for “weekly-magazine printing” in compliance with such a bookbinding method may be made as shown in FIG. 2, for example.

One example of the image layout for “weekly-magazine printing” in compliance with the bookbinding for weekly magazine is shown in FIG. 2, where 7-page images i1-i7 are printed on both sides of each of the sheets A, B as shown.

Specifically, a first side of the sheet A is divided into left-hand and right-hand portions by a folding line L along which the sheet is to be folded into halves after printing, thus having two print regions. The printing is performed based on a layout such that the left-hand print region contains the image i1 whereas the right-hand print region is blank. A second side of the sheet A is also divided into left-hand and right-hand print regions by the folding line L along which the sheet is to be folded into halves. The printing is performed based on a layout such that the left-hand print region contains the image i2 whereas the right-hand print region contains the image i7. A first side of the sheet B is also divided into left-hand and right-hand print regions by the folding line L along which the sheet is to be folded into halves after printing. The image i3 is printed on the left-hand print region whereas the image i6 is printed on the right-hand print region. A second side of the sheet B is also divided by the folding line L into left-hand and right-hand print regions. The image i4 is printed on the left-hand print region whereas the image i5 is printed on the right-hand print region. A booklet resemblant to a weekly magazine may be made by folding the sheets A, B into halves after printing the images, stacking the sheets with their folding lines L aligned, and stapling the sheets on the folding lines L. A user may read the images of the resultant booklet in the order of the images i1, i2, i3, i4, i5, i6 and i7.

Still another example of the collective printing is double-sided printing wherein both sides of a sheet are printed.

The collective printing function of the conventional image forming apparatus has encountered the following problem to be solved.

Specifically, the collective printing function of the conventional apparatus is only able to lay out read images in the order of reading and to print the images thus arranged. Therefore, in the case of the generally called 4-page collective printing, eight read images i1-i8 can be collectively printed on the two sheets A, B, as shown in FIG. 1. However, it is impossible to perform the collective printing when the other image or a blank image is inserted between the read images, as shown in FIG. 3. In FIG. 3, a region represented by a symbol “−” is a region having a printed image independent from the read images or a blank image.

Thus, the collective printing function of the conventional image forming apparatus cannot edit the order of the images are laid out. Hence, the apparatus cannot lay out images read from originals in the order desired by the user. Furthermore, the apparatus cannot perform the collective printing based on a layout where an image from a different source (such as an image stored in a memory) is inserted between the images read from originals.

### SUMMARY OF THE INVENTION

A main object of the present invention for solving the above problem is to provide an image forming apparatus capable of laying out a plurality of images in a desired order for collective printing.

Another object of the present invention is to provide an image forming apparatus capable of laying out for collective printing a plurality of read images and an independently prepared image which can arbitrarily be inserted between the read images and performing the collective printing based on the layout thus made.

Still another object of the present invention is to provide a preferred collective printing method.

In accordance with this invention, an image forming apparatus capable of arranging a plurality of images read from a plurality of originals in a predetermined layout in the order of reading and collectively printing the images, the apparatus comprises re-layout means for inserting an image prepared independently from the read plural images into an arbitrary place of the layout and re-arranging the images by sequentially pushing back the place with the inserted image and the succeeding images.

Such an arrangement can collectively printing in various formats because the plural images read from the originals are laid out in the order of reading and then an image independent from the original images is inserted in an arbitrary place of the layout. The user of the image forming apparatus can obtain collectively printed matters in favorable form. The user can add/insert an arbitrary image into a desired place among the images to make collective printing, depending on the purpose of the printed matters to be used or distributed.

### BRIEF DESCRIPTION OF THE DRAWINGS

FIG. 1 is a diagram illustrative of a collective printing generally called “4-page collective printing”;

FIG. 2 is a diagram illustrative of an exemplary image layout in a collective printing generally called “weekly-magazine printing”;

FIG. 3 is a diagram illustrative of resultant prints made by a collective printing generally called “4-page printing” wherein images from a different source are inserted according to an embodiment of the present invention;

FIG. 4 is a block diagram showing a schematically construction of an image forming apparatus according to one embodiment of the present invention;

FIG. 5 is a flow chart representing the content of a control operation made by a control unit 10;

FIGS. 6A-6F are diagrams each showing a content displayed on a display operation unit 60;

FIGS. 7A-7B are diagrams each showing a content displayed on the display operation unit 60;

FIG. 8 is a diagram illustrating a relationship between a method for reading out images from a memory when the generally called “weekly-magazine printing” is performed, and print regions of sheets where the images are printed; and

FIG. 9 is a diagram illustrative of printed results made by the “weekly-magazine printing” according to one embodiment of the present invention.

### DESCRIPTION OF PREFERRED EMBODIMENTS

The embodiments of the invention will hereinbelow be described in detail with reference to the accompanying drawings.

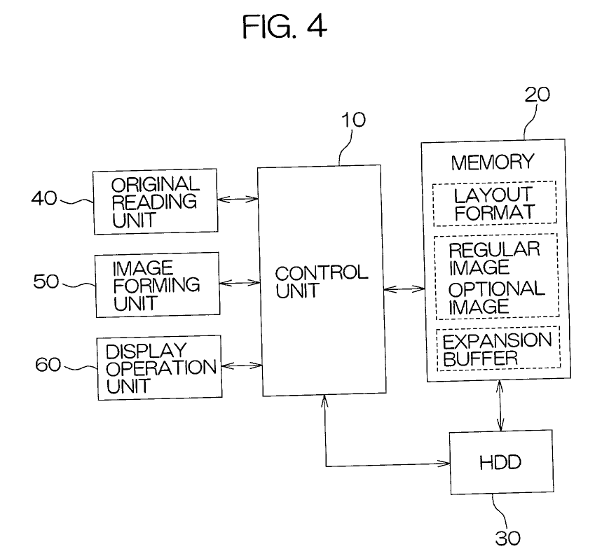

FIG. 4 is a block diagram showing a schematically construction of an image forming apparatus according to one embodiment of the present invention. The image forming apparatus comprises an original reading unit 40 for reading an original image, a memory 20 for storage of image data read out by the original reading unit 40, an image forming unit 50 for recording the image data stored in the memory 20 in the form of a toner image on a sheet or other sheet materials, a display operation unit 60 having a touch panel structure, for example, for displaying ongoing processing performed by the apparatus and for inputting a control signal, a hard disc driver (HDD) 30 for providing a working area for image processing and storing image layout formats and the like, and a control unit for controlling the above portions.

The control unit 10 is adapted to perform an edit function, selection function, transfer function, count function, page-number print selection function and the like by way of the memory 20 alone or the memory 20 and the HDD 30.

The edit function is defined herein as a function to edit the order of the images laid out. The selection function permits the user to select a desired layout from a plurality of layouts, when a plurality layouts are stored in the memory 20 or the HDD 30. In a case where a regular image, optional image or the like is inserted in a desired place by means of the edit function, the transfer function sequentially shifts an image already existing at the place and the succeeding images. Specifically, in a plurality of serially numbered memory regions, the transfer function shifts an image data piece stored in a certain memory region and the succeeding image data to the respective next backward memory regions in sequence. The count function counts a regular image or optional image for insertion as one page the same way as the image read by the original reading unit 40 is counted. The page-number print selection function permits the user to select whether a process for printing a page number on each region of individual images to be collectively printed is performed or not.

These functions are each implemented in a predetermined program, for example.

The memory 20 stores layout formats and predetermined regular image data. The memory 20 further includes a region for storage of optional image data which is optionally captured via communications line (not shown) or the like. The memory 20 also includes a region as an expansion buffer used when the stored image data is subjected to image processing.

The configurations and functions of the control unit 10, memory 20 and HDD 30 can be implemented using the microcomputer technologies, for example.

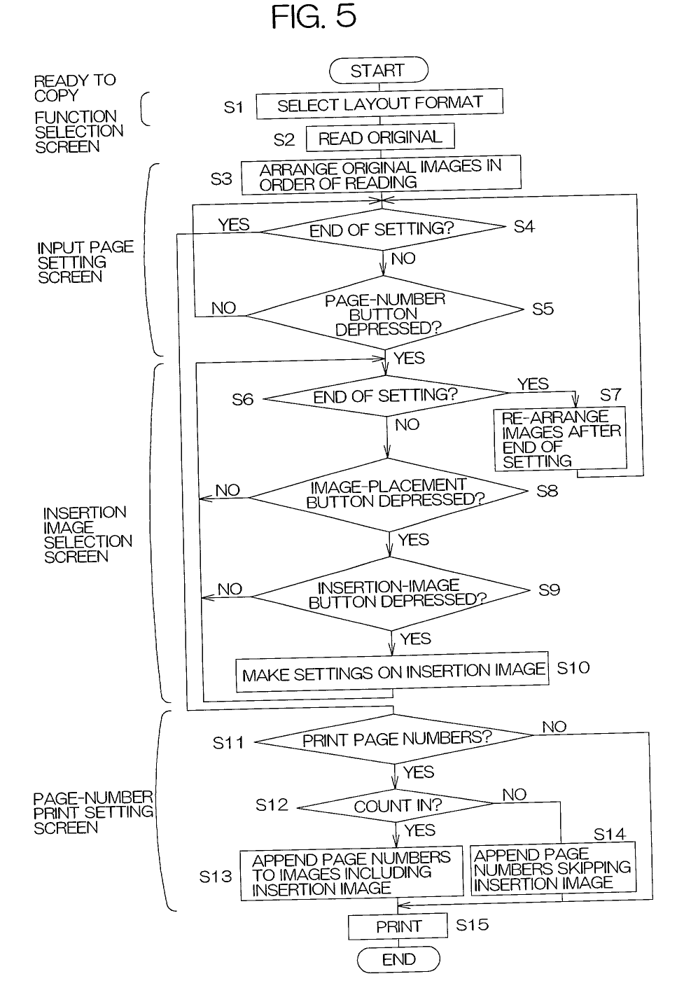

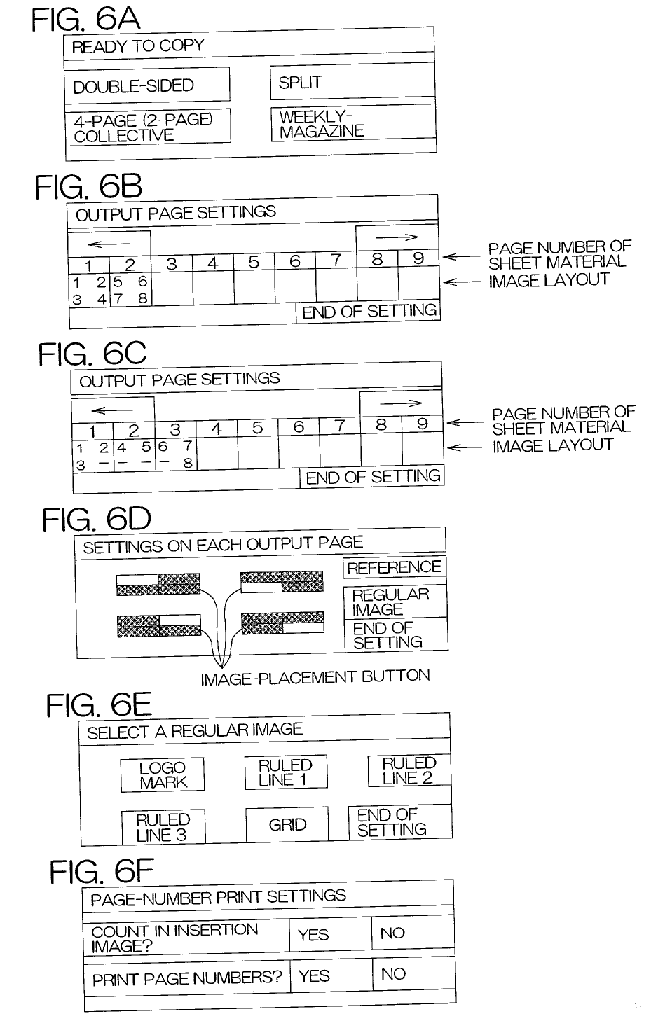

FIG. 5 is a flow chart representing contents of operations performed by the control unit 10 explained with reference to FIG. 4. Incidentally, FIGS. 6A-6F shows contents displayed on a screen of the display operation unit 60 (see FIG. 4) in conjunction with the steps shown in FIG. 5.

The control operations by the control unit 10 will be described according to the flow chart of FIG. 5 and with reference to FIGS. 6A-6F.

When the operation is started, a layout is selected (Step S1). In the layout selection, a display of FIG. 6A appears on the screen of the display operation unit 60. The screen permits the user to select either one from double-sided printing, split printing, 4-page (2-page) collective printing, and weekly-magazine printing. For instance, 4-page collective printing may be selected. It is noted that “4-page collective printing” can be selected by depressing a portion carrying the characters “4-page” of the characters “4-page (2-page) collective printing” and that “2-page collective printing” can be selected by depressing a portion carrying the characters “2-page”.

The following description is made by way of an example where “4-page collective printing” is selected by the user.

When “4-page collective printing” is selected in the layout selection in Step S1 shown in FIG. 5, an original reader (not shown) sequentially reads originals set therein (Step S2). In a case where eight originals are set in the original reader, for instance, these eight originals are read one after another.

Image data read from the eight originals are temporarily stored in the memory 20 to be arranged according to the selected layout and in the order of reading (Step S3). The display operation unit 60 presents a display of FIG. 6B thereby permitting the user to know in what order the read images are arranged.

The display of FIG. 6B indicates that images of four originals are to be collectively printed on a first sheet (a sheet material of page number 1) and that the sheet is divided into four regions, an upper left one of which contains the image of Original 1, an upper right one of which contains the image of Original 2, a lower left one of which contains the image of Original 3, and a lower right one of which contains the image of Original 4.

Similarly, the display also indicates that images of four pages of Originals 5-8 are to be collectively printed on a second sheet (a sheet material of page number 2). Similarly to the first sheet, the images of Originals 5-8 are laid out on the second sheet in the order of the upper left portion, upper right portion, lower left portion and lower right portion.

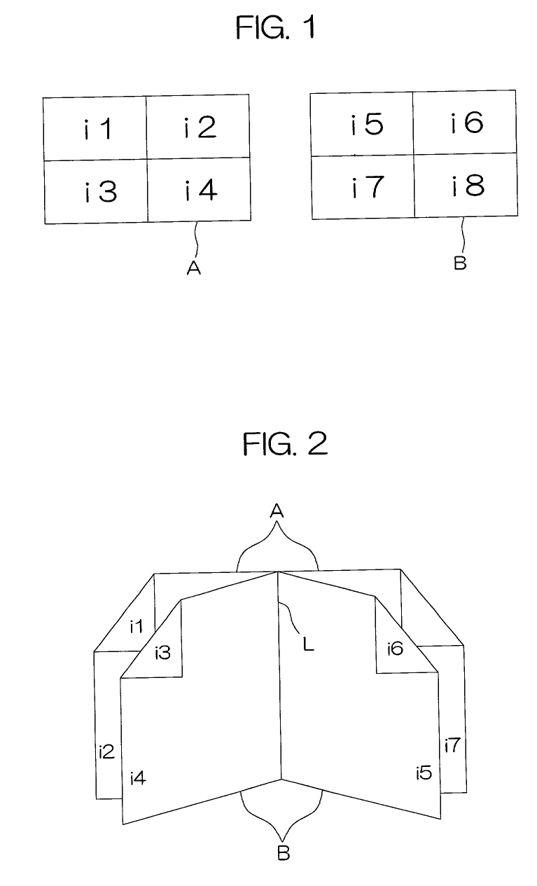

In Step S4 shown in FIG. 5, it is determined whether or not the user confirming the screen of FIG. 6B has depressed an “end-of-setting” button located at a lower right corner of the screen. If the user has depressed the “end-of-setting” button, Step S4 answers “YES” so that the operations proceed to Step S11 where processing for determining whether page numbers are to be printed or not are carried out (Steps S11-S14). Then, the images of the eight originals are collectively printed on two sheets according to the layout shown in FIG. 6B. The resultant prints are those illustrated in FIG. 1.

If the “end-of-setting” button in the screen of FIG. 6B is not depressed, Step S4 answers “NO” and then, determination is made as to whether a page-number button is depressed or not (Step S5). Depressing the page-number button means that the user depresses the page-number button “1” or “2” for the sheet material. If the page-number button is undepressed for a few seconds, the operations circulate through Steps S4, S5 to proceed to Step S11 the same way as when the “end-of-setting” button is depressed.

If the page-number button “1” or “2” is depressed, the screen of the display operation unit 60 is changed to that shown in FIG. 6D while the operations circulate through Steps S6, S8, S9 and S10.

An image placement buttons in FIG. 6D are used for designating any one of the four print regions of the sheet material for insertion of an image other than the read images. There are displayed four such buttons, which differ from one another in the position of a blank region. Depressing any one of the four buttons permits a desired image to be inserted in the blank region of the depressed button.

The screen of FIG. 6D further contains buttons of “reference”, “regularimage” and “end-of-setting”. Depressing the “regular image” button changes the screen to that shown in FIG. 6E which permits the selection of any one of five regular images, for example, including “logo mark”, “ruled mark 1”, “ruled mark 2”, “ruled mark 3”, and “grid mark”. When the user depresses any one of the buttons for the five regular images, Step S9 answers “YES” so that a designated image is inserted in a region designated by the image placement button (Step S0).

Desired images selected from the regular images can be arbitrarily inserted in the four print regions of one sheet material by repeating these operations in cycles.

In a case where Step S8 determines that an image placement button is depressed but Step S9 determines that the button for image insertion is not depressed, a print region designated by the image placement button may be made blank.

In a case where the “reference” button rather than the “regular image” button is depressed, an image stored in a server or a computer connected to the image forming apparatus via communications line or network, for example, may be received so as to be inserted in a print region designated by an image placement button. The operations in this case may be performed the same way as in Steps S6-S10.

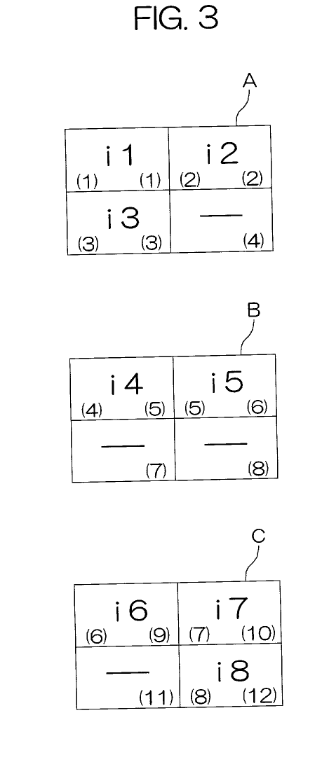

When the “end-of-setting” button in the screen of FIG. 6D or 6E is depressed, the operations proceed from Step S6 to Step S7 where the image data to be subjected to the collective printing are re-arranged. Then, a display of FIG. 6C, for example, appears on the screen of the display operation unit 60. The screen of FIG. 6C indicates that the 4-page collective printing is performed on each of three sheets, as shown in FIG. 3.

If, in Steps S4-S10 shown in FIG. 5, a sheet material of page number 1 is selected and then an image placement button is depressed for insertion of an image in the lower-right print region of the sheet material, an optional image or the like can be inserted in this print region. In this case, the image i4 placed at the lower-right print region of the sheet material of page number 1 is shifted to the upper-left print region of a sheet material of page number 2. This involves sequential shifting of the image i5 at the upper-left print region of the sheet material of page number 2, the image i6 at the upper-right print region thereof, and the image i7 at the lower-left print region thereof to the upper-right print region, the lower-left print region and the lower-right print region, respectively. Then, the layout for the third sheet material is changed such that the image i8 placed at the lower-right print region of the sheet material of page number 2 is printed on the upper-left print region of the third sheet material.

Thus, each time a print region for insertion of an image and an image to be inserted are designated, the sequential image shifting takes place. The screen of FIG. 6C indicates a state where four regular images are inserted. That is, the print region represented by the symbol “−” indicates a region of a regular image or optional image, or a blank region where no image is printed.

When the “end-of-setting” button in the screen of FIG. 6C is depressed, the operations proceed from Step S4 to Step S11. In Steps S11-S14, it is decided whether or not the page number is printed on each individual image to be subjected to the collective printing. In Step S11, a display of FIG. 6F appears on the screen of the display operation unit 60. The screen asks the user whether the page numbers are to be printed or not and whether insertion images are to be counted in or not. If the user depresses “YES” as to whether the page numbers are printed or not, Step S11 answers “YES”. If the user depresses “YES” as to whether the insertion images are counted in or not, Step S12 answers “YES”. If it is determined that the page numbers are printed and the insertion images are counted in (“YES” in both Steps S11, 12), the control unit 10 performs processing for sequentially printing the page number on each print region of images, inclusive of the insertion images, which are subjected to the collective printing (Step S13). Referring to FIG. 3, each of the sheets A-C has four quarter print regions. Numbers in parentheses (1)-(12) at respective lower right corners of the print regions are the page numbers to be appended by the above processings.

In a case where the page numbers are printed but the insertion images are not counted in (“YES” in Step S11 and “NO” in Step S12), out of the images to be collectively printed, the original images read by the original reading unit 40 are subjected to the page number printing whereas no page numbers are printed on the insertion images. That is, the processings are performed for sequentially printing the page numbers on the original images to be printed, skipping the inserted images (Step S14). Such processings are useful in a case where, for example, the insertion image is ruled mark or blank. Referring to FIG. 3, numbers in parentheses (1)-(8) at respective lower left corners of the print regions of the sheets A-C are the page numbers appended by the above processings.

In a case where Step S11 determines that the page numbers are not printed, the page number printing is not performed on the individual images to be subjected to the collective printing.

In Step S15, the collective printing is performed and the resultant prints are those shown in FIG. 3.

Next, the weekly-magazine printing will be described.

When the user depresses a “weekly-magazine printing” button in the screen of FIG. 6A on the display operation unit 60, Step S1 in the flow chart of FIG. 5 performs the layout selection so that the weekly-magazine printing is selected. This is followed by reading originals set in the unillustrated original reader. Where seven originals are set in the original reader, for instance, these seven originals are read in sequence (Step S2).

Image data read from the seven originals 1-7 are temporarily stored in the memory 20 to be arranged according to the selected layout and in the order of reading (Step S3).

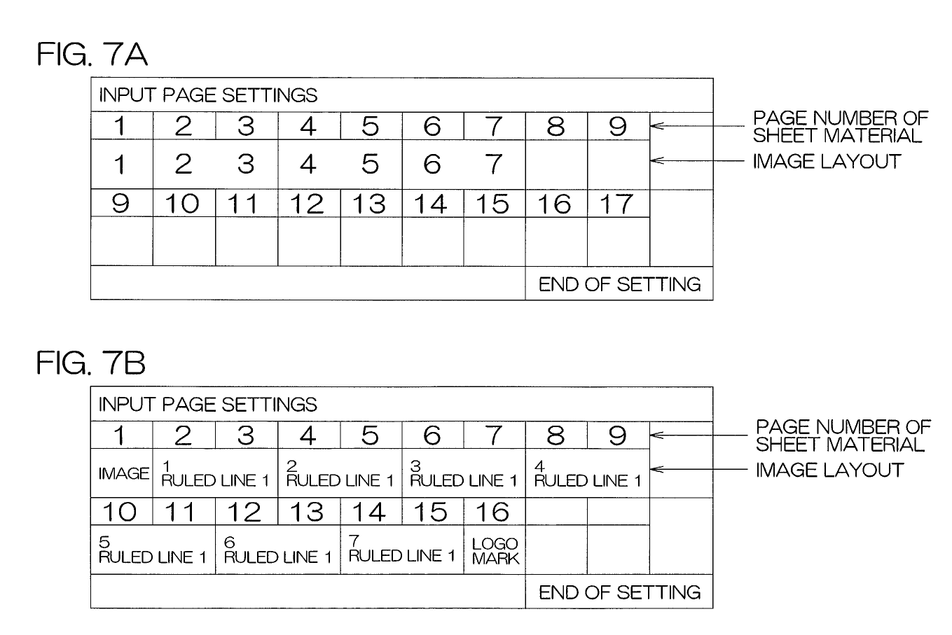

Then, a display shown in FIG. 7A appears on the screen of the display operation unit 60. The screen permits the user to know in what order the read images are laid out. The screen of FIG. 7A indicates that the images of the originals 1-7 are to be printed on sheets in the layout shown in FIG. 2.

Step S4 in FIG. 5 determines whether or not the user confirming the screen of FIG. 7A has depressed an “end-of-setting” button at a lower right corner of the screen. When the user has depressed the “end-of-setting” button, Step S4 gives “YES”, which is followed by Step S1 where determination is made as to whether page numbers are to be printed or not (Steps S11-S14). Then, the weekly-magazine printing is performed for printing 7-page original images on two sheets according to the layout shown in FIG. 7A. The resultant prints are those shown in FIG. 2.

When the “end-of-setting” button in the screen of FIG. 7A is not depressed, Step S4 in FIG. 5 gives “NO”. Subsequently, determination is made as to whether a page number button is depressed or not (Step S5). Depressing the page number button means that the user depresses a portion indicating the page number of the sheet material in the screen of FIG. 7A . If the page number button is undepressed for a few seconds, the operations circulate through Steps S4 and S5 and proceed to Step S11 the same way as when the “end-of-setting” button is depressed.

In a case where the page number button for a sheet material is depressed, the screen of the display operation unit 60 is changed to that shown in FIG. 6E and the operations circulate through Steps S6, S9 and S10. Referring to the flow chart of FIG. 5, Step S8 is required in the case of the aforementioned 4-page collective printing. However, when the weekly-magazine printing is to be made, Step S8 in FIG. 5 is skipped because the screen of FIG. 6D is not appeared in the weekly-magazine printing.

When the screen of FIG. 6E is appeared on the display operation unit 60, the user depresses any one of buttons for insertion images which include “logo mark”, “ruled mark 1”, “image 1”, “image 2”, and “grid mark”, thereby Step S9 gives “YES” so that a selected insertion image is inserted in a region of a sheet material of the page number designated in Step S5 (Step S10).

These operations and processings are repeated in cycles thereby inserting desired images in regions of arbitrary page numbers of sheet materials.

It is noted that the insertion image is not limited to a predetermined image. Similarly to the case of 4-page collective printing, the image forming apparatus, connected to a server or computer via unillustrated communications line or network, may be permitted to receive an image stored in the server or computer and to insert the image thus received.

FIG. 7B shows a state where images are re-arranged after insertion of nine insertion images. Specifically, this state can be established by the following steps. First, a page number (1) of a sheet material is designated while “image 1” is selected as an image to be inserted therein. Then, image data i1-i7 read and stored in the memory 20 are sequentially shifted to backward, respectively. That is, the image i1 of the page number (1) of a sheet material is shifted to page 2; the image i2 of page 2 is shifted to page 3; the image i3 of page 3 is shifted to page 4; . . . and so on. Subsequently, when the page number (3) of a sheet material is designated and “ruled mark 1”, selected to be inserted, the ruled mark 1 is placed on page 3 so that the image i2 on page 3 is shifted to page 4; the image i3 on page 4 is shifted to page 5; . . . and so on. Thus, the image placed on the designated page where another image is inserted thereto and the images on the succeeding pages are sequentially shifted backward by one page.

The screen of FIG. 7B indicates the final state where the nine insertion images have been inserted in this manner.

When an “end-of-setting” button in the screen of FIG. 7B is depressed, the operations proceed from Step S4 to S11. The processings performed in Steps S11-S14 are the same as those done in the aforementioned 4-page collective printing. Specifically, in Steps S11-S14, selection is made between a process wherein the page number is printed on each individual image to be printed in the layout of weekly-magazine printing, and a process wherein the page number is printed on the images read by the original reading unit but is not printed on the insertion images. Based on the selection thus made, how to perform the page number printing is decided.

Subsequently, the printing operations are performed in Step S15.

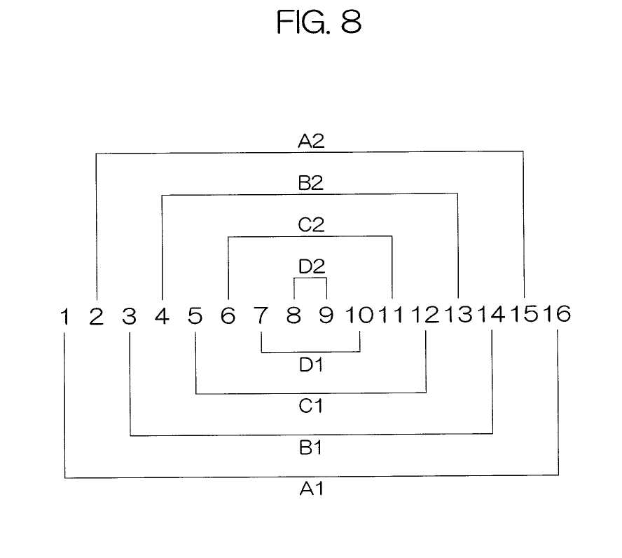

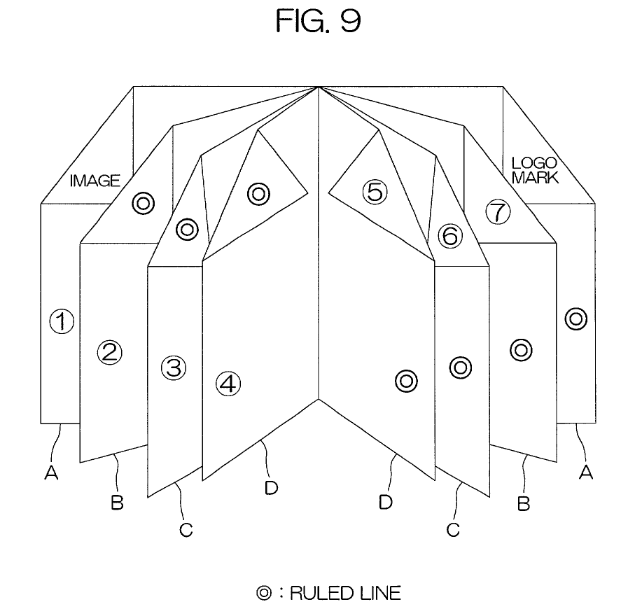

In the printing operations, image data stored as associated with the page numbers 1 and 16 of a sheet material are read out to be printed on the first side of a sheet A in side-by-side relation, as shown in FIG. 8. Further, image data stored as associated with the page numbers 2 and 15 of the sheet material are read out to be printed on the second side of the sheet A in side-by-side relation. Likewise, image data as associated with the page numbers 3 and 14 are printed on the first side of a sheet B; image data as associated with the page numbers 4 and 13 are printed on the second side of the sheet B; image data as associated with the page numbers 5 and 12 are printed on the first side of a sheet C; image data as associated with the page numbers 6 and 11 are printed on the second side of the sheet C; image data as associated with the page numbers 7 and 10 are printed on the first side of a sheet D; and image data as associated with the page numbers 8 and 9 are printed on the second side of the sheet D. The sheets A-D thus printed are bound according to the bookbinding method for weekly magazine, thereby forming a booklet shown in FIG. 9.

In FIG. 9, (1 )-(7) each indicates a region having a printed image read out, “image” and “logo” each indicates a region having a printed image added and inserted, respectively, and ⊚ indicates a region where the ruled mark 1, which is an addition or insertion image, is printed.

In the process order adopted in either the above described embodiments, an original set on the original reading unit is read out after selection of a desired layout (see steps 1 and 2 in FIG. 5).

With the present invention, it is possible to read out the original not only immediately after selecting a layout, but also immediately before printing.

Specifically, in the flowchart shown in FIG. 5, selection of a layout is performed and, thereafter, inputting the number of originals (inputting the number of sheets of originals) is performed instead of reading them out. “8” is inputted with a ten-key and the like for eight sheets of originals and “7” is inputted for seven sheets of originals, for example. The number of originals (number of the sheets of originals) is once inputted, the following processes are performed in accordance with the flow from step S3 to step S14 shown in FIG. 5.

More specifically, when the number of originals is inputted, numbers corresponding to the inputted number of originals are arranged in accordance with the selected layout and displayed on the display operation unit 60, which are shown in FIG. 6B and FIG. 7A. Similarly in the aforesaid embodiment, therefore, a user can insert desired images onto desired pages, respectively, with reference to the display on the display operation unit 60.

And, after originals are read out prior to performing the printing process at step S15 in FIG. 5, the collective printing is performed in accordance with the layout set by means of the collective printing processes.

It is to be noted that the present invention is not limited to the foregoing embodiments and various changes and modifications may be made thereto within the scope of the appended claims.

What is claimed is:

1. An image forming apparatus capable of arranging a plurality of images read from a plurality of originals in a predetermined layout in the order of reading and collectively printing the images, comprising re-layout means for inserting an image prepared independently from the plural read images into an arbitrary place and re-arranging the images by sequentially pushing back the images to the next places, respectively.

2. The image forming apparatus according to claim 1, further comprising:
memory means for storing a plurality of layouts based on which the collective printing is performed;
display means for displaying the types of the plural layouts stored in the memory means; and
selection means for selection of a desired layout from the plural layouts displayed on the display means.

3. The image forming apparatus according to claim 2, further comprising:
second memory means for storing the independently prepared image, wherein plural types of images for addition/insertion are stored;
display means for displaying the addition/insertion images themselves or the types thereof stored in the second memory means; and
selection means for selection of a desired image from the images for addition/insertion displayed on the display means.

4. The image forming apparatus according to claim 3, wherein the images for addition/insertion include a blank image effecting no printing operation on a print region.

5. The image forming apparatus according to claim 2, wherein the independently prepared image includes an image sent to the image forming apparatus via communications line or network.

6. The image forming apparatus according to claim 2, wherein the layouts include a layout for plural-page collective printing.

7. The image forming apparatus according to claim 2, wherein the layouts include a layout for weekly-magazine printing.

8. The image forming apparatus according to claim 3, further comprising means for sequentially appending page numbers exclusively to the images read from the originals out of the images to be collectively printed.

9. The image forming apparatus according to claim 3, comprising means for sequentially appending page numbers to all the images read from the originals and the insertion image for addition, that are to be collectively printed.

10. The image forming apparatus according to claim 3, comprising:
means for selecting between a process wherein page numbers are sequentially appended exclusively to the images read from the originals out of the images to be collectively printed, and a process wherein page numbers are sequentially appended to all the images including the insertion image for addition; and
means for appending the page numbers to the images in the process selected by the selection means.

11. A collective printing method for an image forming apparatus wherein a plurality of images read from a plurality of originals are arranged in a predetermined layout in the order of reading and then are collectively printed, the method comprising the steps of:
inserting an image independent from the images read from the originals into a certain place in the plural original images thus laid out and arranged,
re-arranging the images by sequentially pushing back the images to the next places, respectively, from the place to which the image is inserted, and
collectively printing the re-arranged images.

12. An image forming apparatus capable of arranging a plurality of images read from a plurality of originals in a predetermined layout in the order of reading and collectively printing the images, comprising:
means for inserting an image for addition/insertion prepared independently from the plural read images into an arbitrary place in the layout;
means for sequentially pushing back the images to the next places, respectively, correspondingly the insertion of the image; and
means for performing a collectively printing process with respect to images thus arranged by said insertion means and pushing back means.

13. The image forming apparatus according to claim 12, comprising:
memory means for storing a plurality of layouts based on which the collective printing is performed;
display means for displaying the types of the plural layouts stored in the memory means; and
selection means for selection of a desired layout from the plural layouts displayed on the display means.

14. The image forming apparatus according to claim 13, comprising:
second memory means for storing the independently prepared image, wherein plural types of images for addition/insertion are stored;
display means for displaying the addition/insertion images themselves or the types thereof stored in the second memory means; and
selection means for selection of a desired image from the images for addition/insertion displayed on the display means.

15. The image forming apparatus according to claim 14, wherein the images for addition/insertion include a blank image effecting no printing operation on a print region.

16. A collectively printing method for an image forming apparatus capable of arranging a plurality of images read from a plurality of originals in a predetermined layout in the order of reading and collectively printing the images, comprising:
means for inserting an image for addition/insertion prepared independently from the plural read images into an arbitrary place in the layout;
means for sequentially pushing back the images to the next places, respectively, correspondingly the insertion of the image; and
means for performing a collectively printing process with respect to images thus arranged by said insertion means and pushing back means.
